(19) United States
(12) Patent Application Publication
(10) Pub. No.: US 2024/0198375 A1
(43) Pub. Date: Jun. 20, 2024

(54) STRUCTURE WITH FOAM FOAMING DEVICE FOR GEOENGINEERING

(71) Applicant: Anjin HIRASHIKI, Urasoe-shi, Okinawa (JP)

(72) Inventor: Anjin HIRASHIKI, Urasoe-shi, Okinawa (JP)

(21) Appl. No.: 18/555,384

(22) PCT Filed: Mar. 31, 2022
(86) PCT No.: PCT/JP2022/016852

§ 371 Date: Oct. 13, 2023

(30) Foreign Application Priority Data
Apr. 16, 2021 (JP) 2021-069706

(51) Int. Cl. B05B 17/04; B63B 35/00; B64B 1/02; B64D 1/16

(52) U.S. Cl. CPC B05B 17/04; B63B 35/00; B64B 1/02; B64D 1/16

(57) ABSTRACT

A structure with a foam foaming device for geoengineering is characterized by (A) having an effective relative velocity difference with the atmosphere so that the desired location of the structure in contact with the atmosphere can generate turbulence that decomposes foam, and (B) being capable of maintaining an effective relative velocity difference with seawater so as to be able to generate wake waves that decompose foam which has fallen to the surface of the water from a foam outlet. In one embodiment, the structure is a ship.

### TECHNICAL FIELD

The present invention relates to a technology for geoengineering in which a foam produced by foaming is broken down and thinly dispersed and spread.

### BACKGROUND ART

The Japanese term “awa” (bubble/foam) encompasses both air bubbles and foam. An air bubble is created when air is enveloped in a liquid or solid membrane, and foam indicates a substance formed when air bubbles are gathered and joined together. Soap bubbles are “awa” (bubbles), and such bubbles are easily created when washing dishes in the kitchen or doing laundry. In the natural world, forest green tree frogs produce a foam with their body fluid and lay their eggs in this foam, and these eggs are protected in the foam for 1 to 2 weeks until they become tadpoles. Further, it is also known that mantises lay their eggs in a foam where the eggs spend the winter. In 2019, a large amount of foam washed up on a beach in Chennai in the southeastern region of India (FIG. 1). This foam remained even four days after it had appeared, and it is believed to have been caused when sewage flowed into the ocean due to heavy rains and mixed with detergent residue.

A fire extinguishing method which uses a liquid membrane foam that is generated on a large scale using motive power is widely used to extinguish fires that occur in oil or electric facilities, large oil storage tanks, and the like. Furthermore, as a solid membrane, in FIG. 2, examples include: (a) a film packaging bag in which snack confectionaries are packaged and sold, the bag being in a form which is sealed off from outside air; (b) an air cushioning material of the same embodiment formed by one or more independent air bubbles 1; and (c) an air cushioning material which is known by the product name Puti Puti. These are considered to be bubbles created by membranes which are solid resin films. Sponges and styrene foam and the like are also a type of foam.

An air circulation method in which bubbles are generated at the bottom of a ship when the ship is traveling to reduce resistance between the ship bottom and the water is being implemented, and there have been attempts to utilize the bubbles generated in this way to reflect sunlight (Non-Patent Publication 1).

Foam fire extinguishing methods include high foaming devices which generate foam locally in large amounts. Methods in which flames or combustible materials are covered in large amounts of foam during a fire outbreak to cool them and extinguish the fire by cutting off oxygen from the outside air are widely used. These methods include an aspiration type (for example, Patent Publication 1) and a blower type (for example, Patent Publication 2). There is also a method in which foam is directly dispersed over crops (for example, Patent Publication 3).

### PRIOR ART PUBLICATIONS

### Patent Publications

Patent Publication 1: Japanese Unexamined Utility Model Application, Publication No. H05-53660
Patent Publication 2: Japanese Unexamined Utility Model Application, Publication No. S55-67748
Patent Publication 3: Japanese Unexamined Patent Application, Publication No. 2011-30456

### Non-Patent Publications

Non-Patent Publication 1: “Measuring Reflection Rate of Bubbles Generated by Air Circulation Method”, Nao Shimizu, Suginori Iwasaki (National Defense Academy of Japan)

### SUMMARY OF INVENTION

### Technical Problem

However, bubbles in water generated by an air circulation method are not easily diffused due to the viscosity of water and the normal velocity of ocean currents, and only spread over a range of about 1.5 times the normal wake, and thus the bubbles spread no farther than the periphery of the ship and it has been difficult to spread the bubbles over a wide area.

Further, a large quantity of foam is generated when using a foam generating device for extinguishing fires. However, the purpose thereof is to extinguish a fire by covering the origin of the fire with a large amount of foam to cool it and cutoff air so as to suppress the evaporation of combustible gas, and the clumps of foam are left to diffuse on their own as they collapse and spread due to their own fluidity. Thus, the purpose of these devices was not to thinly spread and diffuse the foam. Further, when spraying agricultural chemical agents, the chemical agent is sprayed downwards so that the foam is applied only to furrowed crops in order to use the chemical agent effectively, and thus the chemical agent does not deviate from a limited range.

An object of the present invention is to produce a foam using conventional high-foaming bubble generation equipment and actively break down a large quantity of foam clumps generated by high foaming, which are difficult to break down as the bubbles themselves, and further thinly spread and diffuse the foam over a wide area so as to improve the albedo of a region.

### Solution to Problem

A structure including a bubble generation device for geoengineering, in which the structure is characterized by being:
(A) a structure having an effective relative velocity difference with respect to the atmosphere so that a desired area of the structure which contacts the atmosphere can generate turbulence which breaks down bubbles; or
(B) a structure that can maintain an effective relative velocity difference with respect to seawater so that wake waves which break down foam that has dropped onto the water surface from a bubble discharge port can be generated.

A structure including a bubble generation device for geoengineering, in which the structure is characterized by being:
(A) a structure having an effective relative velocity difference with respect to the atmosphere so that a desired area of the structure which contacts the atmosphere can generate turbulence which breaks down bubbles; or
(B) a structure that can maintain an effective relative velocity difference with respect to seawater so that wake waves which break down foam that has dropped onto the water surface from a bubble discharge port can be generated, and
in which the structure includes a turbulence generation device, a foam cutter, or a wave maker for breaking down released bubbles.

The structure is characterized in that:
in one of the above structures, at least one foaming device is installed, to which a rotary vane that also serves as a turbulence generation device, a foam cutter, or a wave maker is attached near the bubble discharge port.

The structure is characterized in that:
the structure is a ship equipped with a bubble generation device, in which an expandable frame capable of projecting over the ocean surface from the ship's side is attached onto the deck of the ship, and at least one foaming device, to which a rotary vane that also serves as a turbulence generation device, a foam cutter, or a wave maker is attached near a bubble discharge port, is attached on the expandable frame, so that each bubble discharge port faces downward or to the rear when the expandable frame has been extended to the outside.

The structure is characterized in that:
the structure is a ship equipped with a bubble generation device, in which a tower is installed onto the deck of the ship, the tower extending up into a strong wind region having an effective relative velocity difference with respect to the atmosphere so that a desired area which contacts the atmosphere can generate turbulence, in which a blade projecting to the left and right is attached to an upper part of the tower, and in which foaming devices, to each of which a rotary vane that also serves as a turbulence generation device, a foam cutter, or a wave maker is attached near a bubble discharge port, are attached to the blade separated by a distance such that bubbles which are released do not interfere with each other, and the discharge ports are oriented opposite the traveling direction of the ship.

The structure is characterized in that:
the structure is a ship equipped with a bubble generation device, in which a tethered balloon device is installed onto the deck of the ship, in which in the tethered balloon device, a foaming aqueous solution is pressure fed through a hose which also serves as a tethering rope to a tethered balloon which has been raised into a strong wind region in the sky having an effective relative velocity difference with respect to the atmosphere so that a desired area which contacts the atmosphere can generate turbulence, and foam which has been generated with a wave generator suspended from the tethered balloon and discharged from a discharge port is broken down minutely by a rotary vane that also serves as a turbulence generation device, a foam cutter, or a bubble maker and dispersed into the atmosphere.

The structure is characterized in that:
the structure is a free airship which can travel through a strong wind area where a desired area which contacts the atmosphere can generate turbulence, in which the free airship is equipped with a bubble generation device, and a foaming device, to which a rotary vane that also serves as a turbulence generation device, a foam cutter, or a bubble maker is attached near a bubble discharge port, is installed.

The structure is characterized in that:
the bubble generation device generates bubbles to be discharged which have a lower specific gravity than the atmosphere so that the bubbles obtain buoyancy from the atmosphere after separating from the bubble discharge port and accelerate on their own to continue to rise and separate from subsequent bubbles and diffuse as the distance from the subsequent bubbles increases.

### BRIEF DESCRIPTION OF DRAWINGS

FIG. 1 is a photograph of foam that washed up on a beach in Chennai.

FIG. 2 shows types of film bubbles.

FIG. 3 is a schematic view of sunlight entering seawater.

FIG. 4 is a schematic view illustrating the advancement of incident light which passes through the inside of a single bubble.

FIG. 5 is a schematic view of incident light advancing through foam.

FIG. 6 is a complete perspective view of a simple experimental device.

FIG. 7 is a cross-section view in the X-Y direction of the simple experimental device.

FIG. 8 is a perspective view of a small ship that is traveling while operating a foaming device.

FIG. 9 is a perspective view of a medium ship that is traveling while operating a foaming device.

FIG. 10 is a view illustrating the attachment and assembly of foaming devices onto a pantagram-type frame.

FIG. 11 is a schematic view of a traveling tanker with a foaming device attached to a tower thereof.

FIG. 12 is a cross-section perspective view of a foaming device.

FIG. 13 is an arrangement view of multiple tankers with respect to a rectangular region with the same surface area as the Australian continent.

FIG. 14 is a schematic view illustrating a case in which a tethered balloon device is installed onto a deck.

FIG. 15 is a schematic view illustrating a case in which a tethered balloon device is installed on a vehicle.

FIG. 16 is a conceptual view illustrating a case in which bubbles are dispersed over a desert.

FIG. 17 is a schematic view illustrating a case in which a free airship traveling through the stratosphere disperses bubbles in a region to its rear.

FIG. 18 is a side view and a plan view of FIG. 17.

FIG. 19 is a schematic view of a ship equipped with a film membrane bubble foaming device and an aqueous membrane bubble foaming device.

FIG. 20 illustrates a ship that disperses bubbles in a bubble layer and a bubble cloud.

FIG. 21 illustrates a foam made of multiple layers that do not share a membrane.

FIG. 22 is a conceptual view of dispersing bubbles onto a road.

FIG. 23 is a conceptual view of dispersing bubbles to respond to a heat wave.

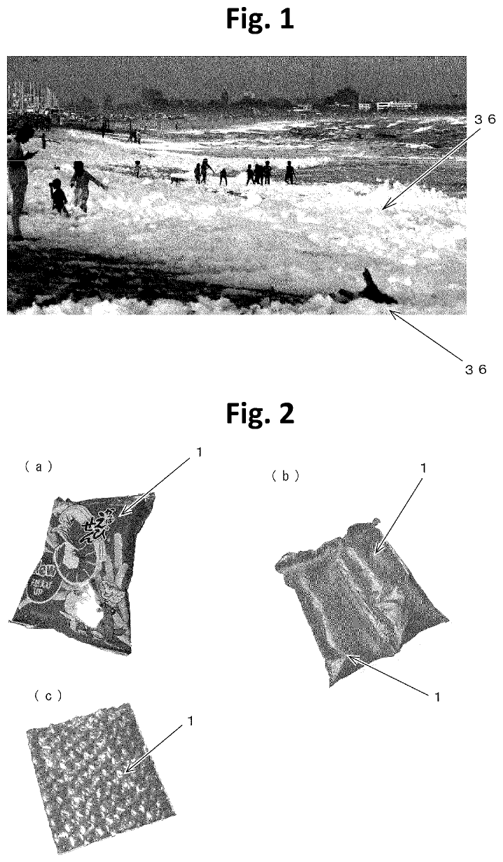

### DESCRIPTION OF EMBODIMENTS

Embodiments for carrying out the invention will now be explained using Embodiment 1 to Embodiment 7.

### Embodiment 1

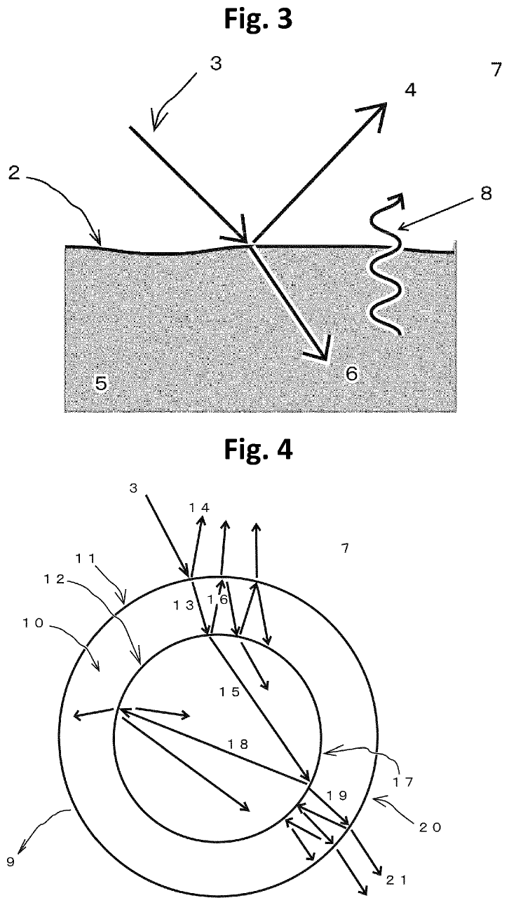

In Embodiment 1, the structure that is equipped with a bubble generation device for geoengineering which can generate turbulence near a discharge port and which produces waves that break down and diffuse a foam that has dropped onto a water surface is a ship, and Embodiment 1 shall be explained using FIGS. 3 to 10.

Light is reflected at the surface of a boundary formed by two different mediums. A normal substance on a ground surface, such as soil, rock, a concrete surface, an asphalt surface, a metal surface, an ocean surface, a snow surface, and desert sand, has one reflection surface at the boundary formed between the substance and the atmosphere, and light is reflected at this reflection surface. Any light which is not reflected heats up the substance, and then is radiated from these substances to the outside as radiant heat 8 having a long wavelength. However, the radiant heat 8 having a long wavelength is absorbed by greenhouse gases such as carbon dioxide and water vapor, and thus cannot easily escape outside the earth, and this is a cause of rising temperatures in global warming.

FIG. 3 is a schematic view of sunlight entering seawater 5. From the upper left, incident light 3 which has reached the ocean surface 2 is divided into reflected light 4 and refracted light 6 which refracts and enters into the seawater 5. The reflected light 4 which was reflected returns to an incident-side space 7, and the remaining refracted light 6 enters the seawater 5 and is used to heat up the seawater. As indicated above, the seawater 5 has one reflection surface called the ocean surface 2. However, a single bubble 9 in the atmosphere has four reflection surfaces 11, 12, 17, and 20 with respect to the incident light 3.

FIG. 4 is a schematic view illustrating the advancement of the incident light 3 which passes through the inside of a single liquid-membrane bubble 9. The advancement of the incident light 3 is depicted by enlarging the thickness of a membrane 10 for ease of understanding. The incident light 3 is split into refracted light and reflected light every time it encounters a reflection surface, and light which is oriented in a downward direction is attenuated. Further, light which has entered into two reflection surfaces is split into refracted light and reflected light every time it encounters a reflection surface, and the reflected light is again split into refracted light and reflected light every time it encounters a reflection surface, resulting in multiple reflections. Ultimately, transmitted light 21 that passes downward through the bubble becomes weaker than light that passes through the ocean surface 2 which has only one reflection surface.

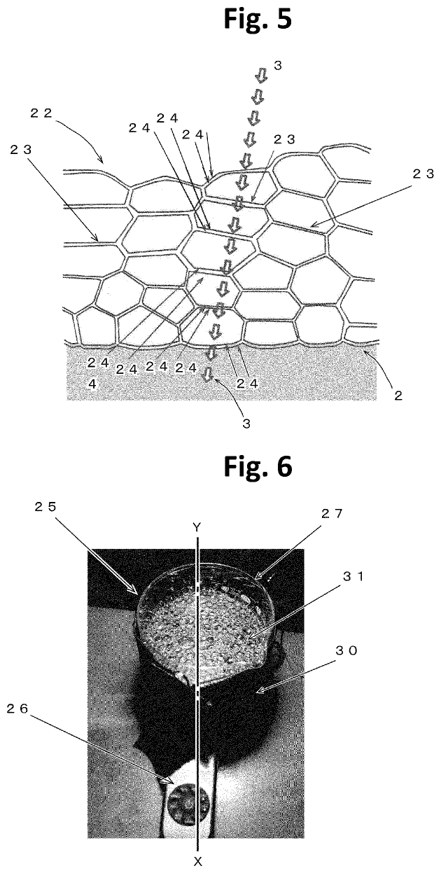

As explained above, the single bubble 9 has four reflection surfaces. Further, a foam in which n bubbles are connected in a sunlight direction has 2n+2 reflection surfaces. This shall be explained below. FIG. 5 is a cross-section schematic view of a state in which a foam 22 of connected bubbles is floating on the ocean surface 2. The boundary between adjacent bubbles is in a state of sharing a single membrane 23. The number of reflection surfaces of the foam in which n bubbles are stacked in the direction of the incident light 3 is 2n+2. In the case of FIG. 5, when counting from the ocean surface 2, there are 5 bubbles which are connected and stacked in the direction in which the incident light 3 advances from above. Therefore, the incident light 3 from above must get through 12 reflection surfaces in order to pass through the foam 22 and escape downward.

When the advancing light hits a reflection surface 24, the light is divided into reflected light and transmitted light, and is further subjected to multiple reflections by the reflection surfaces before and after each enclosed space, and the light which transmits downward is attenuated. The enclosed spaces are represented by 2n+1, and when 5 bubbles are stacked as in the case of FIG. 5, there is a total of 11 enclosed spaces through which the incident light 3 must pass. The foam, which is stacked in 5 levels in the direction in which the light enters, has 11 enclosed spaces and 12 reflection surfaces, and is thus advantageous in terms of light reflection compared to a normal substance on the ground which has a single reflection surface. Incidentally, sunlight which has entered a bubble is reflected at the same short wavelength at the reflection surface and then travels upward into the sky. However, this sunlight is not easily absorbed by carbon dioxide and thus escapes as is to the outside of the earth. Therefore, this is advantageous in terms of reducing the heat balance of the earth.

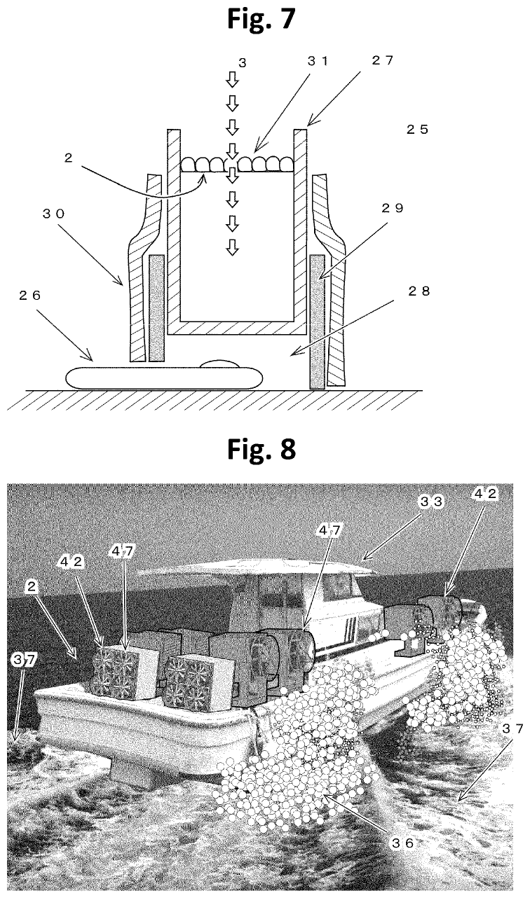

The transmittance of sunlight by a bubble was measured. FIG. 6 is a complete perspective view of a simple experimental device 25, and FIG. 7 is a cross-section view in the X-Y direction of the simple experimental device 25. Table 1 shows the values found for the sunlight blocking rate by a bubble from the measurement results. A simple illuminance meter 26 was used for the measurements. To give an overview of the simple experimental device 25, water was placed in a beaker 27 which is illuminated from above by an LED light source, and then the illuminance depending on the presence/absence of a bubble layer 31 produced on the water surface 2 was measured with the simple illuminance meter 26 placed under the beaker 27. In order to reduce the influence of miscellaneous light, the periphery of the beaker 27 was covered with a black cloth 30.

TABLE 1
Measurement of Light Transmittance

| | | | | Average | Transmittance |
|---|---|---|---|---|---|
| | First | Second | Third | (LUX) | % |
| Only water | 7270 | 7260 | 7230 | 7253 | 100% |
| One bubble layer | 6520 | 6480 | | 6500 | 89.6% |
| 2 to 4 bubble layers | 5560 | 5770 | 5860 | 5730 | 79% |

In Table 1, the transmittance was measured in three cases: the surface of only water with no bubbles; the surface of water when covered with one layer of bubbles; and the surface of water when covered with an average of 3 layers. Since it is difficult, given our facilities and technology, to create layers in which bubbles are precisely layered in 2, 3, or 4 layers, these were mixed and the transmittance was measured as an average of 3 layers. Assuming that the light transmittance in the case of the surface of only water with no bubbles was 100%, the light transmittance with one layer of bubbles was 89%. Further, the light transmittance in the case of a foam with an average of 3 layers was 79%.

With just 1 to 3 layers, a relatively large sunlight reflection power and light blocking effect was exhibited, and clumps of foam having from several tens to several hundreds of layers which is used in high-foaming foam fire extinguishing is unnecessary if the objective is light reflection and light blocking. Since bubbles have multiple reflection surfaces which are advantageous for such reflection, if bubbles generated in large quantities can be thinly dispersed over a desired area of the earth to cover the surface, it would be possible to improve the albedo of the area.

The regions of the ocean which are involved in warming are not regions having a small surface area, but rather regions with a large surface area. The amount of heat per m² of sunlight is small, but the amount of heat becomes massive when accumulated over a wide surface area, and this leads to strengthening of typhoons and the El Niño phenomenon, etc. Any measures against such warming must improve the albedo of a wide surface area, such as an area the size of the Australian continent.

In considering ways to improve the albedo of the ocean over a wide area, one possibility is to add an object that reflects sunlight, in other words a new reflection surface, between the ocean and the sun. For example, it is conceivable that spreading a thin film made of resin onto the ocean surface would be the most economical and thus better. However, while it is possible to cheaply produce an artificial film that is extremely thin, if such film is spread over a wide area, it would be difficult to maintain the planar surface of the film unless tension was applied on the planar surface from the front, back, left, and right. In order to stretch out the film, a frame that supports such tensile force would be necessary. This would not be a problem if the area was small, but for the ocean with a wide surface area, even more than the costs of film production, the costs for a frame for maintaining a planar surface and a mechanism for stretching would be huge, and this is unrealistic. In a bubble, there is a balance between the gas pressure within the bubble and the surface tension of the thin membrane, and while small, a bubble occupies its own volume in the atmosphere. If such bubbles are spread out, then the same effect as spreading out a film would be exhibited.

In recent years, it has been theorized that coral reefs in the tropical and subtropical regions are facing large-scale damage such as a whitening phenomenon or death due to an increase in seawater temperature caused by global warming. In order to suppress such heat-related environmental deterioration in the coral reef ocean regions, FIG. 8 presents a perspective view illustrating a case in which the structure equipped with a bubble generation device for geoengineering of the present invention is a small ship 33 with a shallow draft that is capable of traveling through coral reef ocean regions, in which the ship travels while operating some foaming devices 42.

The bubble generation device is realized by connecting, via dedicated piping, and installing foaming devices which are used in foam fire extinguishing equipment. Seawater is used as a water source, and the seawater is pumped up with a pressurized water feeding device (not illustrated). The seawater is mixed in a mixer (not illustrated) with a bubble raw material from a bubble agent storage tank (not illustrated) provided within the ship, and then sprayed onto a foaming net 32 from a spray nozzle (not illustrated).

Foaming devices which are used in foam fire extinguishing equipment include low/medium foaming types and high foaming types, etc. However, since a greater foaming ratio is advantageous for effective utilization of the foaming stock liquid, in the present invention, a high-foaming approach is used. Among such high-foaming approaches, there are currently two types: a blower type and an aspiration type. Herein, a commercially-available aspiration-type foaming device 42 is used, which produces foam in an amount of 500 m³/min at a foaming rate of 500-fold with an aqueous solution flow rate of 1 m³/min. In the aspiration-type foaming device 42, the aqueous solution is mixed with air because air is sucked in by the eductor effect produced when spraying, and a foam 36 is generated upon contact with the foaming net 32, and this foam is continuously released from a bubble discharge port 46 and dispersed onto the ocean surface 2.

If the relative velocity difference between the traveling ship and the air is large, turbulence that breaks down the bubbles is readily formed at the surface of the structure near the bubble discharge port 46. However, if the turbulence is weak and there is little break down of the clumps of foam 36 that are discharged, the foam 36 may be broken down by attaching a rotary vane 47, which serves as a turbulence generation device and a foam cutter, near the bubble discharge port 46. The foam is broken down minutely when the rotary vane 47 rotates, and if the vane further has a shape which feeds air in the discharge direction like a blower, the clumps of foam which have been cut and made small can be separated and dispersed.

When the ship 33 is stopped, the discharged foam 36 stops near the stopped ship and does not spread out. When traveling over the ocean, the ship creates a wake wave 37 which spreads in a V-shape from the bow toward the rear. When the foam 36 drops down onto this wake wave, the clumps of foam 36 are further broken down by the wake wave 37, and as the traveling ship 33 moves, the drop-down point of the discharged foam 36 also moves successively, and thus the foam drops down successively onto the wake of the ship 33 and is diffused and dispersed to the rear of the ship 33. The foam 36 which has dropped down onto the ocean surface is subsequently further broken down and spreads over the ocean surface as time passes due to wind and waves on the ocean surface and due to the fluidity of the bubbles themselves.

In the ship 33 described herein, four of the above-described foaming devices 42 are installed at the front of the ship and six are installed at the rear of the ship for a total of 10. For a case where using this ship, bubbles are dispersed in the Sekisei Lagoon, which is Japan's largest coral reef located between Ishigaki Island and Iriomote Island, a calculation of the time and required bubble raw material amount was simulated. The surface area of Sekisei Lagoon is 400 km², and thus a region with a square-shaped area of 20 km per side shall be considered below.

Each foaming device 42 produces foam in an amount of 500 m³/min, and thus ten of these devices produces 5000 m³/min, and the divided width per each pass of the ship is set to 400 m. In other words, assuming that, as time passes, the clumps of foam discharged from the discharge ports 46 will spread to a width of 400 m with a thickness of about 2 cm, the ship should advance at a velocity of 625 m/min. Thus, in one hour, the ship's velocity will be 37.5 km/hour, which is a velocity of about 20.25 knots. If a 20 km width is divided into 400 m widths per each pass, this corresponds to 50 passes. If one ship makes 50 passes over a distance of 20 km, then all passes will be complete in about 26 hours and 40 minutes.

The amount of the bubble aqueous solution used by each foaming device 42 is 1 m³/min, and thus about 16000 m³ of the bubble aqueous solution is used in 26 hours and 40 minutes. Normally, the ratio of a bubble agent used in foam fire extinguishing equipment is 1 to 6%. Herein, since performance on the level of foam used for fire extinguishing is not required, assuming a 1% aqueous solution, the amount of the bubble stock liquid is 160 m³ and the remaining 99% is seawater. If the ship can carry about 160 m³ of the bubble stock liquid, then the bubble dispersement can be completed in 26 hours and 40 minutes. If the bubbles remain without disappearing for at least 26 hours and 40 minutes, then the Sekisei Lagoon can be covered, although in a patchy state, with bubbles after about 26 hours and 40 minutes.

If the dispersed bubbles formed about three layers with a thickness of about 2 cm, assuming that the bubbles are dispersed over about 70% of the region since they are in a patchy state, upon referring to the experimental results, it is possible to reduce the light transmittance of this 70% region to 79%, and it is conceivable that light would be reflected upward in the remaining approximately 210%. Therefore, the amount of sunlight that had being warming the seawater can be reduced, and thus it is possible to suppress an increase in the seawater temperature.

Next, a case of dispersing bubbles over the Great Barrier Reef of Australia is simulated. The area of the Great Barrier Reef is 348700 km², which corresponds to about 872 times greater than the area of the Sekisei Lagoon. This area is considerably increased, but the system and number of facilities need only be increased proportional to the increased area. Thus, no new technology is required, and the hurdle to achieving this is not high.

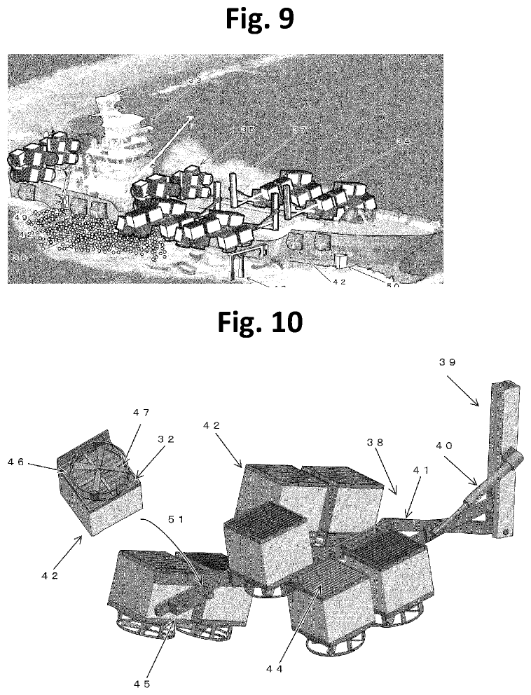

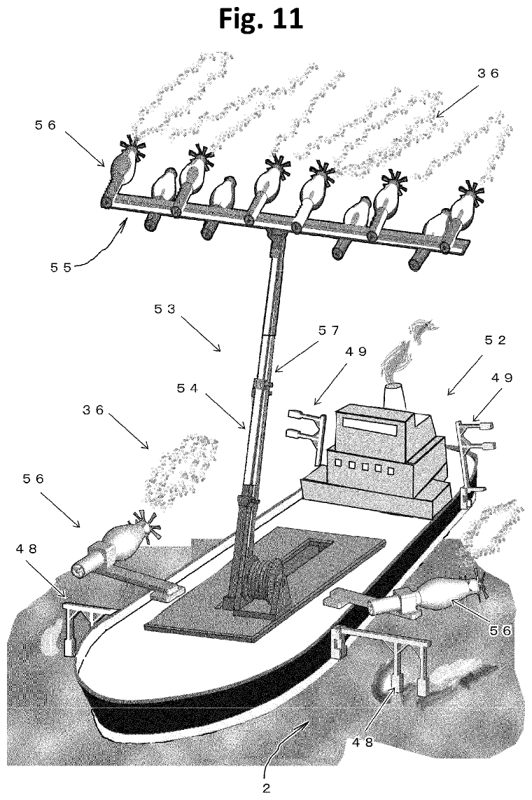

Since the capacity of the ship used for the Sekisei Lagoon described above was small, a ship equipped with 74 of the foaming devices 42 is considered in FIG. 9. The foaming devices 42 are attached to an expanding/contracting pantagram-type support frame 38 that protrudes out from the ship's side toward the ocean. FIG. 10 is a disassembled deployed view showing the foaming devices 42 being assembled to the pantagram-type support frame 38, with one remaining foaming device 42 which has not yet been assembled thereto.

Each pantagram-type support frame 38 consists of a set of six sections 41. In the two sections 41 at the front end and the two at the middle for a total of four sections 41, two foaming devices 42 are attached to each of these sections 41 for a total of eight foaming devices. Each foaming device 42 is attached, near the discharge port 46 or near an air intake port 44, to the respective pantagram-type section 41 via a stilt 45, and the foaming devices are attached so that they do not collide with each other during expansion/contraction, and so that they do not interfere and collide with a pantagram support guide 39, a driving hydraulic cylinder 40, and the like.

In a state 35 in which the pantagram-type support frame 38 to which a total of eight foaming devices 42 are attached is contracted and stored, the eight foaming devices 42 are folded and stored in the side of the ship. In a state 34 in which the pantagram-type support frame 38 is deployed so as to protrude far out toward the ocean, the discharge ports 46 of the eight foaming devices 42 are oriented toward the ocean surface 2. The foaming devices 42 can also be installed so that the discharge ports 46 are oriented toward the rear. Since there are eight of the pantagram-type support frames 38, a total of 64 foaming devices 42 are mounted. In addition, a total of ten foaming devices 42 are attached on the left and right at the front and rear portions of the ship's hull, resulting in a total number of 74 foaming devices.

A large quantity of foam 36 is discharged onto the ocean surface 2 in clumps from the discharge ports 46. By utilizing the pantagram-type support frames 38, the discharge ports 46 of adjacent foaming devices do not come near each other, and the clumps of foam 36 which are discharged from each discharge port do not interfere with each other and fall down onto the ocean surface separately. As the velocity increases, turbulence is more easily generated at the surface of the traveling object, and thus the clumps of foam are easily split. If the foam is not easily split with the normal wind and the turbulence generated near the discharge ports, the rotary vanes 47 may be operated to split the foam.

The clumps of foam which have dropped onto the ocean surface are further broken down by the wake wave 37 produced by the traveling ship. The bow of a normal ship is designed as, for example, a spherical bow so as to cancel out any waves and reduce the wave resistance. However, in the case of a ship for dispersing bubbles, the bow may conversely be designed so that waves are created to produce a large wake wave 37.

If the waves produced by the ship are insufficient, two types of wave makers are attached to the hull so as to further create waves. A wave maker 48 is lowered into the ocean during use, and when the ship is traveling, the portion which is in the ocean hits against the seawater to produce waves. The wave maker in a stored state is indicated as reference numeral 49. A fixed-type wave maker 50 is attached to as to protrude outward from the hull, and hits against the seawater when the ship is traveling so as to produce waves.

The area of the Great Barrier Reef is 348700 km², and thus it shall be considered below as a square-shaped region in which each side is 590.5 km. Since the foaming amount of each foaming device is 500 m³/min, the amount of foam produced by 74 of the foaming devices is 37000 m³/min. Therefore, if the divided width per each pass of one ship is set to 3000 m, or in other words assuming that the foam is to be spread over a width of 3000 m at a thickness of about 2 cm, the ship should travel at a velocity of 37 km/hour.

If a width of 590500 m is divided by the width per each pass of 3000 m, this corresponds to about 197 passes. Further, the time to cross 590.5 km is about 16 hours. Thus, if one ship makes 197 passes over a distance of 590.5 km per pass, this would take about 3141.35 hours.

Assuming that the lifespan of a bubble is 32 hours or more, in order completely disperse the bubbles over the region of the Great Barrier Reef within the lifespan of the bubbles, a single ship would not be sufficient, and multiple ships should be used. If the shared load of each ship is set to only one round trip (two passes), and the 197 passes (98.5 round trips) are performed using 99 ships simultaneously to share the load and disperse the bubbles, the time required would be 32 hours per ship.

The amount of the bubble aqueous solution used by each foaming device is 74 m³/min, and thus a total of 13947610 m³ of the bubble aqueous solution would be needed over the 3141.5 hours. If the bubble agent therein is 1% of the bubble aqueous solution, this would be 139476.1 m³, and dividing this among the 99 ships, the share per each ship would be about 1409 m³. Thus, each ship should be loaded with about 1409 m³ of the bubble stock liquid. By dispersing the bubbles simultaneously using 99 ships which are each capable of carrying 1409 m³ of the bubble agent at one time, it would be possible to cover, although in a patchy state, the Great Barrier Reef with bubbles in about 32 hours, and thereby the albedo can be improved.

### Embodiment 2

In Embodiment 2, the structure that is equipped with a bubble generation device for geoengineering is a ship on which a tower that can maintain a height at which turbulence is easily generated is mounted, and Embodiment 2 shall be explained using FIGS. 11 to 13.

In order to store and transport a large quantity of bubble raw material, the bubble raw material can be stored in a tank. In FIG. 11 in which a 10,000-ton class tanker 52 capable of traveling over the ocean is used, a folding boom-type tower 53, similar to those used in, for example, a raw concrete pressure feeding vehicle or a collapsible fire truck that discharges water to high places, is installed on the tanker deck. The bubble raw material stored within a bubble storage tank (not illustrated) of the tanker 52 is mixed with pumped up seawater in a mixer (not illustrated) to produce a foaming bubble aqueous solution, and this bubble aqueous solution is pressure-fed by a pressurized water feeding device (not illustrated) through a pipe 57 disposed along a boom 54 to foaming devices 56.

A method for producing large quantities of foam locally in a short amount of time utilizes a blower-type high-foaming equipment which is used in foam fire extinguishing equipment. Herein, a method shall be explained in which clumps of foam produced in large quantities locally in this manner are spread thinly over a wide area of the ocean and then diffused and dispersed, so as to improve the albedo of a wide area of the ocean.

The boom 54 is extended upward until the tower 53 reaches an area of the sky where the air current is strong, and a blade 55 disposed so as to be spread and project to the left and right is attached to an upper part of the tower 53. Ten foaming devices 56 are attached, spaced apart from each other, to the blade 55 so that the discharged clumps of foam do not interfere with each other, and so that the turbulence generated near a discharge port 65 of each foaming device does not interfere and cancel out the turbulence generated by any other foaming device. Furthermore, two foaming devices 56 are installed on the deck, so that a total of twelve foaming devices 56 are mounted.

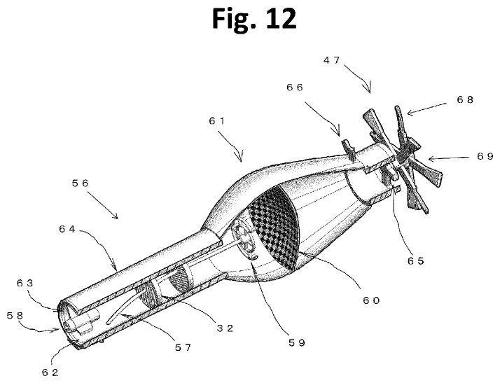

FIG. 12 is a cross-section perspective schematic view of the foaming device 56. A large electric jet fan 58 used in a blower for tunnel exhaust is used, and the capacity and number of bubble aqueous solution spray nozzles 59 is increased accordingly so as to increase the amount of spray, and the area of a foaming net 60 stretched within a tube 61 is also increased. The bubble generation amount of a blower-type bubble generation device can be increased proportionally as the capacity of the equipment is increased. Therefore, since the foaming devices 56 of the bubble generation device are made to be larger, all of the devices added to the bubble generation device, such as the pressurized water feeding device (not illustrated), the mixer (not illustrated), and the pipe 57, are also made larger accordingly.

In the layout of the foaming device 56, the jet fan 58 is attached via an attachment fixing plate 63 at the center of a front air inlet port 62, two flow control plates 67 for suppressing flow velocity are attached to the rear of the jet fan 58, and then a plurality of the spray nozzles 59 are positioned to the rear of the flow control plates 67, the tube 61 in which the foaming net 60 is stretched is positioned to the rear of the spray nozzles 59, and the bubble discharge port 65 is located at the end. The foaming bubble aqueous solution that has been fed to the foaming device 56 is dispersed onto the foaming net 60 by the spray nozzles 59, and when air is pressure-fed by the jet fan 58 onto the mesh which is evenly wetted, foam 36 is produced continuously and in large amounts by the air passing through the mesh.

A turbulence generator 66, which is a projection that easily generates turbulence, may be attached to the surface of a structure near the discharge port 65 of, e.g., the tower 53, the blade 55, or the foaming device 56. High places which are separated from the ground surface have little friction with the ground surface, and generally the wind velocity is high. The clumps of foam 36 discharged from the foaming devices 56 at the top of the high tower 53 readily generate turbulence at the surfaces of the tower 53, the blade 55, and the foaming devices 56, etc.

If the relative velocity difference between the external air current velocity and the surface of the structure is large, strong turbulence is easily generated and break down of the foam is readily promoted. However, if the turbulence is weak and the break down of the foam does not seem to proceed, a rotary vane 47 that is rotated by power or by wind and that serves as a turbulence generation device and a foam cutter may be attached to the rear the bubble discharge port 65. The rotary vane 47 attached to the foaming device 56 is an unpowered rotary vane that is rotated by the wind, and consists of two fans at the front and rear which rotate in opposite directions from each other. An outside vane 68 rotates upon receiving wind, and a cutting blade 69 is on the inside. Foam 36 which has left the bubble discharge port 65 is cut by the cutting blade 69 to be made smaller, and then is made even smaller by the turbulence generated around the fan. Since there is a distance between the tower and the ocean surface, the time of exposure to the wind becomes longer, and thus the foam is split and diffused further until it falls onto the ocean surface 2.

Four wave makers 48, 49 are installed on the hull, and these wave makers hit the ocean water during travel to generate waves, and the foam that has fallen onto the ocean surface is broken down by the energy from these waves. Since the point of discharge of the bubbles also moves along with the movement of the tanker, the foam can be diffused and dispersed, although in a patchy state, within a desired region. The foam 36 which has fallen onto the ocean surface 2 is broken and split on the ocean surface due to its own fluidity as well as by the wind and waves, and thus, although in a patchy state, is further thinly spread and diffused to cover the ocean surface 2.

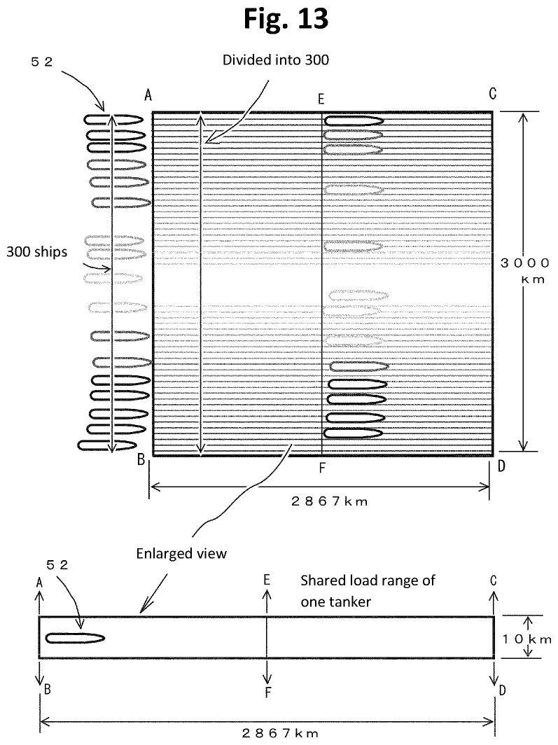

A case of using the above-described equipment to disperse bubbles over the ocean in an area equivalent to the Australian continent is simulated. The area of the Australian continent is 8,600,000 km². Therefore, in FIG. 13, this will be envisioned as an ocean with the size of a rectangle ABCD in which the longer sides are 3000 km and the shorter sides are 2867 km.

As the blower used in the blower-type high-foaming devices, a large jet fan 58 which is used for ventilation of a tunnel or the like is used. The jet fan 58 is produced to have a discharge amount of 138 m³ per second, and this is why such a jet fan is used. Ignoring any pressure loss due to the foaming net 60 or the spray nozzles 59, etc., 138 m² of foam is continuously produced every second by the foaming aqueous solution which is sprayed and the air which is pressure-fed by the jet fan 58. If twelve foaming devices are operated simultaneously, then 1656 m³ of foam is produced every second. As long as the bubbles can stably exist in the atmosphere, the size of the bubbles can be any size, from the size of fine valves to several tens of centimeters or several hundreds of centimeters.

It is assumed that the divided width of bubble dispersement per one tanker is 10 km per a single pass. In other words, it is assumed that the foam dispersed from the tower of one tanker is broken down by turbulence and the rotary vane, etc. and further split upon exposure to wind, and then after falling onto the ocean, this foam spreads out to a width of 10 km along with the passage of time due to the waves and wind and due to the fluidity of the bubbles themselves. If foam in an amount of 1656 m³ per second is spread to a thickness of about 2 cm over a divided width per tanker of 10 km, the length in the traveling direction is 8.28 m per second. If the tanker advances 8.28 m in one second, then the tanker would reach a distance of 29.8 km in one hour. Since this can be regarded as the velocity, the tanker would take about 96.2 hours to cross the length of 2867 km at a velocity of 29.8 km/hour. In terms of days, this would take about 4 days.

If the lateral width of 3000 km is divided into widths of 10 km, the result is 300 passes. Given that the lifespan of a bubble is up to 5 days, one tanker would not be sufficient, and thus the load is shared by multiple tankers. If the shared load of each tanker is set to one crossing of 2867 km, then 300 tankers in total would be necessary. The bottom half of FIG. 13 is an enlarged schematic view of the shared load range of one tanker. If 300 tankers 52 are lined up side-by-side spaced apart by 10 km intervals on a line between A and B, and start dispersing bubbles at the same time, given that the lifespan of the bubbles is up to 5 days, an area of the ocean equivalent to the Australian continent can be covered, although in a patchy state, by bubbles with a thickness of 2 cm in 4 days at a velocity of 29.8 km/hour (16.1 knots), and thereby the albedo of the ocean in this region can be improved.

If the degree of foaming of the foaming device is 1000-fold and a 1% foaming bubble stock liquid is used, the bubble aqueous solution required for one pass is 573400 m³. Since 99% is seawater, the amount of bubble stock liquid to be loaded in each tanker is the remaining 1% which is 5734 m³. Considering the amount which can be carried by a 10,000-ton class tanker, the bubble dispersement can be achieved without any refilling during the process. If the period was divided in half to two days, the region of the rectangle ABCD could be split into two, i.e. ABFE and EFDC, and the number of tankers could be increased by 300 for a total of 600. If the added 300 tankers were lined up side-by-side spaced apart by 10 km intervals on a line EF and started at the same time as the tanker group on the line AB, then the region of ABCD could be covered with bubbles in half the time, i.e., about two days.

The amount of bubble stock liquid required for the entire area of 8,600,000 km² is about 1,720,000 m³. The annual discharge amount of carbon dioxide in the entire world is 33,000,000,000 tons (2019). If the specific gravity of the amount of bubble stock liquid is set to 1, this corresponds to only about 0.00005% of the annual discharge amount of carbon dioxide. If bubble dispersement was repeated every ten days for a total of 3 times a month, and this was carried out over the three months of the summer season for a total 9 times, then the amount of bubble raw material used would only reach about 0.00047% of the annual discharge amount of carbon dioxide.

If a surfactant made from fish oil as a raw ingredient, or fish proteins, seaweed such as kelp, or the like is used as the bubble raw material, the burden on the ocean and the environment can be reduced, and it may be possible to create bubbles with a long lifespan. The bubbles used in fire extinguishing are known to have an effect of suppressing combustible vapors by covering over a combustible liquid. With regard to the lifespan of an aqueous bubble, moisture, which is a component of the bubble membrane, evaporates and the bubble membrane becomes thin, and thus the membrane cannot be maintained and the membrane ruptures. However, when bubbles cover the ocean surface, the evaporation of water vapor from the ocean is absorbed by the bubble membrane which extends the lifespan of the bubble membrane. This water vapor, which normally evaporates from the ocean surface to impart energy to rain clouds and tropical depressions, is absorbed by the bubble membrane, and this suppresses the evaporation of water vapor into the sky while extending the lifespan of the bubble membrane.

If the above is possible, then the albedo can be improved by dispersing foam over the ocean, which will suppress an increase in seawater temperature. If the amount of evaporated water vapor can be suppressed, then the development of rain clouds which cause heavy rains can also be suppressed. The current countermeasures against heavy rains consist mainly of water usage systems for after heavy rains have occurred such as expanding and reinforcing dams and retaining walls. Bubble dispersement suppresses the generation and development of heavy rain clouds, and thus can be regarded as a countermeasure against the generation source of such heavy rain clouds.

The large amount of latent heat, which emerges when water vapor in high-temperature, high-humidity air that is heated by sunlight in tropical ocean areas rises and condenses into cloud droplets, warms and lightens the surrounding air and strengthens rising air currents. Thus, this latent heat becomes an energy source which causes typhoons to develop. However, if large quantities of foam are dispersed in advance in regions where typhoons develop, the foam can reflect the sunlight which would have heated the ocean into outer space before the sunlight is absorbed by the ocean, and this may suppress increases in the temperature of seawater in the ocean, thereby reducing the generation amount of water vapor which is an energy source for typhoons, and in turn suppressing the development of typhoons.

A phenomenon of ice melting at the South Pole and the North Pole has been occurring, and this phenomenon weakens the westerly winds and is also believed to be a cause of heatwaves. By mounting the above-described bubble generation device to an ice breaking ship or the like that travels into icy seas such as the Antarctic Ocean so as to disperse bubbles over the ocean of a polar region, the sunlight energy that had been increasing the seawater temperature can be reduced and a rise in the seawater temperature can be suppressed, and thereby the melting of ice at the polar regions can be inhibited. If the bubbles dispersed over the ocean are carried by wind to the tops of icebergs at coastal areas and then the bubbles freeze there together with falling snow, ice with air mixed therein, which exhibits high heat insulation, can be formed, and this ice will not easily melt due to sunlight or the outside air temperature.

When the water temperature at the ocean surface in ocean regions monitored for the El Niño phenomenon is higher than in an average year, the El Niño phenomenon occurs, and it is theorized that this phenomenon causes various abnormal weather events. Since the source of increases in the seawater temperature is solar energy, covering a desired ocean region with bubbles at a desired time over a desired period can decrease the amount of sunlight energy which causes increases in the seawater temperature, and thus phenomena like the El Niño phenomenon which occur due to such increases in the seawater temperature can be suppressed.

In a turbo prop engine or a turbo fan engine with which outside air can be mixed into the exhaust gas and the temperature of exhaust gas can be lowered, if the amount of outside air in the exhaust gas can be greatly increased or if water is sprayed into the exhaust gas such that the temperature of the exhaust gas is decreased to the extent that the bubble generation temperature is not affected, such an engine may be used instead of the jet fan 58, and this may enable an overall decrease in size. Further, the above-described embodiments are premised on the use of a specialized ship. However, a bubble generation device which has been decreased in size or which has been configured as a unit that can be added later may be installed on the hull or stem, etc. of a regular line ship to disperse bubbles over the ship's course.

### Embodiment 3

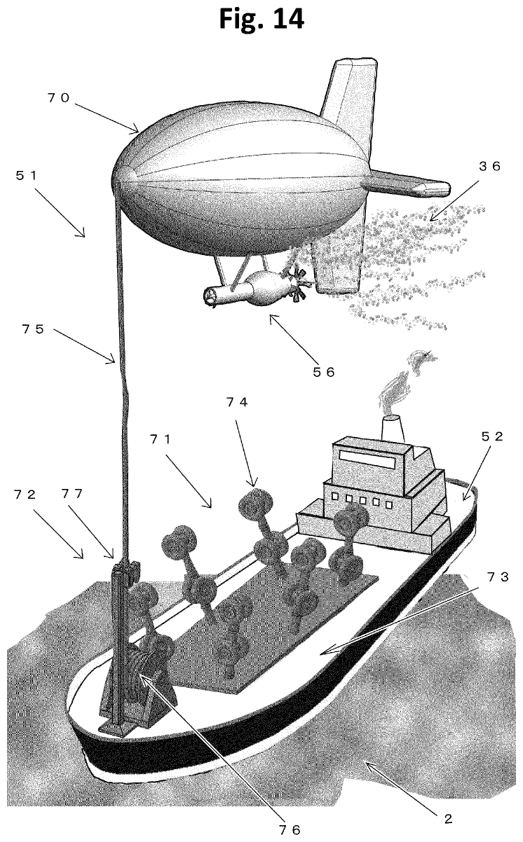

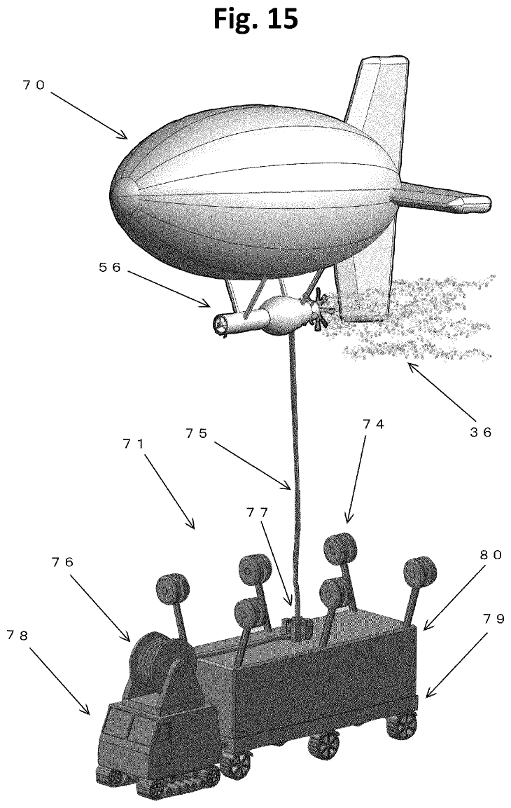

In Embodiment 3, the structure that is equipped with a bubble generation device for geoengineering is a ship on which a tethered balloon device, which can be raised into a strong wind region in the sky at which turbulence is easily generated, is mounted, and Embodiment 3 shall be explained using FIG. 14.

In this case, the tethered balloon can more easily obtain height than the tower 53, and since there is less friction with the ground as the height increases and stronger winds can be more easily obtained, a tethered balloon device 51 is mounted on a tanker deck 73. On the tanker deck 73, a restraint device 71 for releasing and adhering a tethered balloon 70 from/to the ship, as well as a tethering device 72 are installed.

Restraint units 74 of the restraint device 71 for releasing and adhering from/to the ship consist of a combination of soft airbags shaped like rotating tires. When the balloon contacts these restraint units, the restraint units move together in the up-down direction and the left-right direction so as to not resist against the direction in which the balloon outer skin moves, thereby reducing impacts to the balloon outer skin. The restraint units 74 are installed at six locations, and during takeoff/landing of the balloon, the restraint units softly hold the tethered balloon 70 from left and right at the center and from diagonally left and right at the front and rear to restrain the tethered balloon.

The tethering device 72 is constituted by a storage device 76 for a tethering rope 75, a feeding device 77 for the tethering rope 75, and the like. The tethered balloon 70 is raised into the sky while being tethered by the tethering rope 75 which has been fed out, and a foaming device 56 is suspended from the bottom part of the tethered balloon 70. An opening at the entrance side of the foaming device 56 is an air inlet port 62. When the outside air current velocity is high, bubbles are generated by air flowing from the outside into a casing 64. When the outside air current velocity is low, a jet fan 58 is operated to feed air for generating bubbles. The foam which is discharged is cut minutely by a rotary vane 47 that serves as a turbulence generation device and a foam cutter which is rotated by motive power or by the wind, and thereby the foam is broken down and discharged.

In the case of Embodiment 2, the pipe 57 disposed along the boom 54 of the tower 53 fed the foaming aqueous solution from the ship body of the tanker 52 to the foaming devices 56 at the top of the tower 53. In the case of the tethered balloon 70 which moves upon being blown by the wind, a rigid pipe or the like cannot be used. Therefore, a flexible, tough woven hose is used, similar to that used in fire extinguishing equipment in which Kevlar fibers or the like having a high tensile strength are woven together. In other words, a cylindrical hose having a hollow hose-like shape with enough strength to be capable of tethering is used as the tethering rope 75, while the inside thereof can also serve as a hose for pressure-feeding the foaming aqueous solution.

A power transmission cable (not illustrated) for driving a jet fan and a control cable (not illustrated) for driving a rudder and the like are also disposed on the tethering rope 75. In recent years, a compressed air foam system (CAFS) has come to be used in fire trucks. The use of this system is advantageous in that, for example, the bubble aqueous solution becomes lighter and the handling of the hose becomes easier. This system may also be utilized for feeding water.

### Embodiment 4

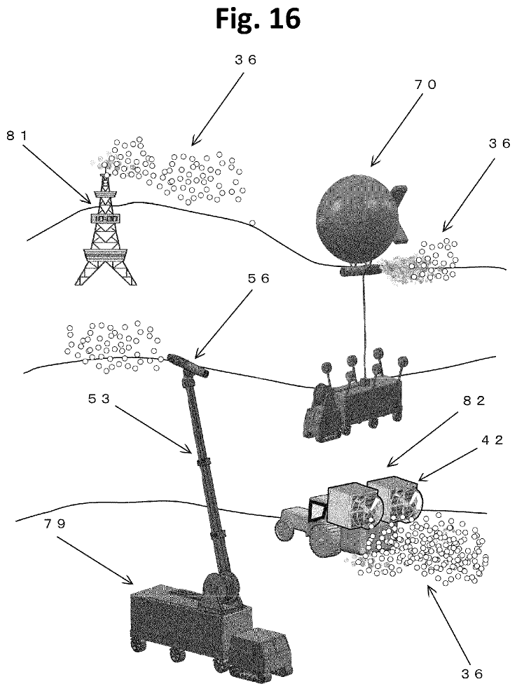

In Embodiment 4, the structure that is equipped with a bubble generation device for geoengineering is a vehicle on which the tethered balloon device 51, which can be raised into a strong wind region in the sky at which turbulence is easily generated, is mounted, and Embodiment 4 shall be explained using FIGS. 15 and 16.

In FIG. 15, a trailer 79 is attached to a caterpillar-type or tire-type tractor 78 which can travel over rough roads or over land, and the tethered balloon device 51 used in Embodiment 3 is mounted thereon. The tractor enters a desired land region, and therein the tethered balloon 70 is raised into the sky to disperse bubbles 36 from the sky. The tethering rope storage device 76 and bubble aqueous solution supply equipment (not illustrated) are mounted on the tractor 78, and the restraint device 71 used during takeoff/landing of the tethered balloon 70 as well as a storage tank 80 for the bubble aqueous solution, etc. and the tethering rope feeding device 77 and the like are mounted on the trailer 79. The tethering rope 75 is fed out to raise the tethered balloon 70 to a desired altitude, and then the foaming device 56 is operated to disperse bubbles.

In this embodiment, bubbles can be dispersed in regions where a ship cannot enter, such as desert regions, plains, snowfields, and on ice. In a desert region, dispersing bubbles can increase the ratio of sunlight that is reflected into the sky, and thus can suppress an increase in the temperature of the ground surface and the air temperature, suppress the evaporation of water vapor, and lower the dryness in the desert region, which facilitates reforesting. Further, it is also possible to disperse bubbles into the sky over a city. By disposing the vehicle of this embodiment near a city and dispersing bubbles into the sky over the city, an increase in the temperature of artificially coated objects such as the concrete of a building and asphalt on a road can be suppressed, and thus a rise in the air temperature of a city can be inhibited, and the amount of power used for air conditioning in the city can be decreased and heat island phenomena can be alleviated.

FIG. 16 illustrates a case in which the above-described embodiments are combined to disperse bubbles in a desert. The equipment of the tethered balloon 70 may be mounted on the trailer 79 shown in FIG. 15, or Embodiment 2 can be applied to a vehicle, so as to mount and dispose the bubble generation device in the form of the foldable tower 53 to the trailer 79. Further, a bubble generation device can be disposed on a ground installation-type tower 81 which is positioned in the wind so as to disperse bubbles from a foaming device 56 at the top of this tower. In addition, a vehicle 82 capable of traveling over the desert and equipped with a bubble generation device having a foaming device 42 provided with a foam cutter which also serves as a bubble blower may be utilized to disperse foam.

### Embodiment 5

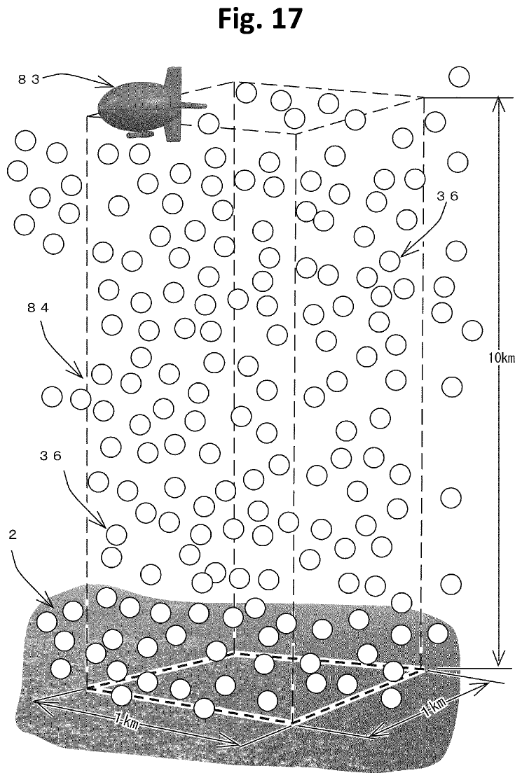

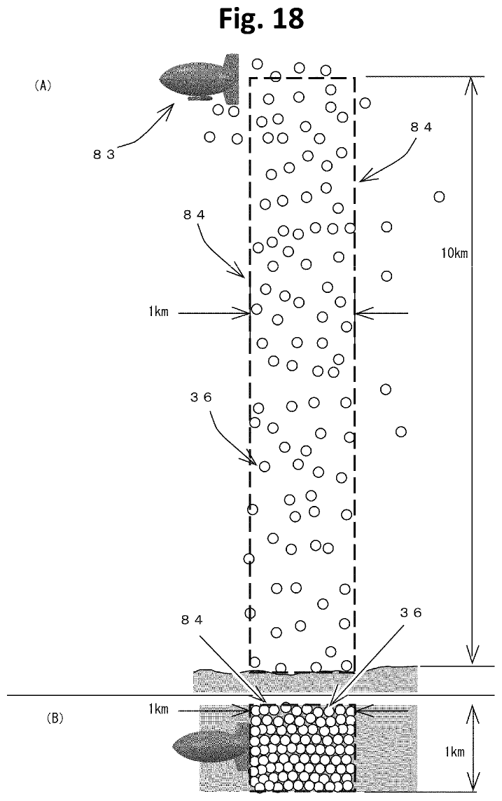

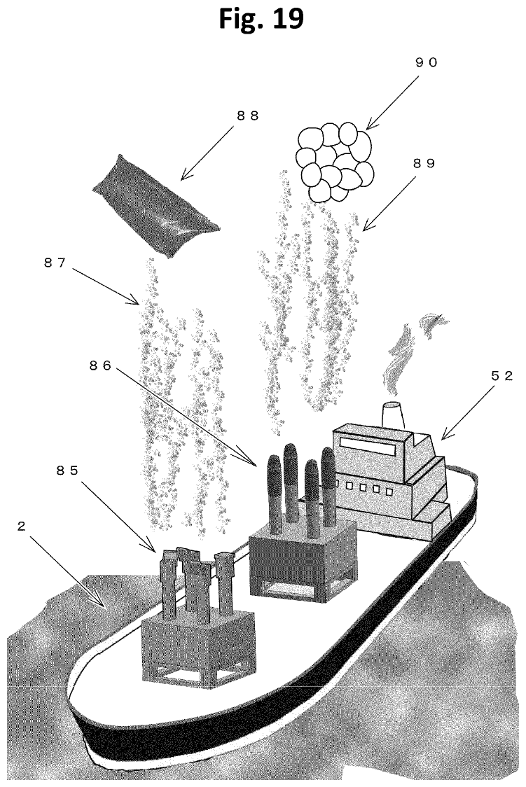

In Embodiment 5, the structure that is equipped with a bubble generation device for geoengineering is realized by mounting a bubble generation device on a free airship which can travel through the sky in the atmosphere where the air current velocity is high and turbulence can be easily generated, and bubbles are dispersed using this free airship. Embodiment 5 shall be explained using FIGS. 17 and 18.

A free airship 83 is inconvenient in that its loading capacity is small, and the set of foaming devices required for the bubble generation device such as the bubble aqueous solution storage tank, the pressurized water feeding device, the foaming device 56, and the like must each be mounted individually. The free airship 83 also has another inconvenience because if the raw material is depleted, the free airship must return to a supply base and be supplied with more raw material. However, if the airship is free and not tethered, it is not restricted by the tethered rope and can travel freely, and thus is capable of dispersing bubbles at various places and in upper layer regions of the atmosphere at altitudes where the airship can ascend. The foaming device 56 that is mounted thereon is equipped with the rotary vane 47 at a discharge port as in Embodiment 3.

FIG. 17 is a perspective view schematically illustrating a case in which the free airship 83 traveling through the stratosphere at an altitude of 10 km in the sky disperses bubbles 36. In order to make the distribution of the bubbles 36 easier to see, a region of a rectangular parallelepiped 84 with a height range of 10 km in which the flat surface has a square shape with four sides of 1 km is envisioned behind the free airship 83, and the bubbles 36 which have been dispersed and then float within this space are depicted. The bubbles 36 are also schematically depicted to be large. The bubbles 36 which have been dispersed to the rear of the free airship 83 are separated and spread by turbulence and wind and gradually float downward, finally falling on an ocean surface 2 and floating on the ocean surface 2 until they burst.

FIG. 17 is a schematic perspective view, and the upper portion of FIG. 18 is a side view (A) when viewed from the side and the lower portion of FIG. 18 is a plan view (B) when viewed from the top. In the side view (A), the bubbles 36 are separated from each other by large intervals, but in the plan view (B), the intervals are small and the bubbles are densely packed. The horizontal projection area of the side view (A) is 10 times the area of the plan view (B). The number of bubbles is the same, and thus the intervals between the bubbles in the plan view (B) is 1/10 of the intervals in the side view (A). Hence, the bubbles are densely packed in the plan view (B).

The objective of Embodiment 1 and Embodiment 2 was to cover the ocean surface 2 with bubbles as thoroughly as possible, or in other words to cover the ocean surface with a filter of the bubbles 36. However, in the plan view (B) of FIG. 18, in terms of sunlight from above, there is very little gap between the bubbles and the bubbles are spread all over, and thus the same effect is being achieved as that when spreading bubbles over the ocean surface which is the objective of Embodiment 1 and Embodiment 2. If the amount of the bubbles 36 in Embodiment 1 and the amount of the bubbles 36 when viewed from the sunlight direction in Embodiment 4 are the same per unit area, then the same degree of effect in terms of sunlight reflection is achieved. The free balloon ship of Embodiment 5 is a dedicated navigation body. However, if the bubbles can be stably discharged at the cruising velocity of a normal airplane, then a compact bubble generation device can be mounted to a regular airplane and bubbles can be dispersed over its route.

As compared to bubbles on the ocean surface or bubbles in the lower layers of the atmosphere, light reflected by bubbles located in the upper layers of the atmosphere has a smaller chance of colliding with greenhouse gases because the distance for the light to escape outside the earth is shorter. Therefore, in terms of sunlight reflection, these bubbles located in the upper layers of the atmosphere are advantageous. Further, the bubbles 36 are generally adsorptive, and thus it is believed that bubbles dispersed in the upper layers of the atmosphere will adsorb greenhouse gases as they fall to the ground or the ocean surface. In addition, carbon dioxide dissolves in water relatively easily, and thus it is believed that carbon dioxide will be easily adsorbed by the membrane of bubbles with a large moisture content. If the bubbles which fall onto the ocean surface are made of a material which does not easily dissolve in seawater, the bubbles will float on the ocean surface, and thus it is possible to collect these bubbles together with their adsorbed atmospheric pollutants.

The free airship can also easily enter forest lands, and when dispersed in the sky over a forest land, the bubbles will fall down into the forest land while reflecting sunlight. Moreover, while falling, the bubbles will adsorb carbon dioxide and water vapor in the atmosphere, and if these bubbles fall into a forest land and break down releasing the carbon dioxide and water vapor, the forest having the absorption/consumption activity of the carbon dioxide and water vapor, they will be easily absorbed by the forest due to photosynthetic activity. Further, unlike water, the bubbles are not readily absorbed by the ground surface, and bubbles which have fallen into a forest land will adhere to the leaves, branches, and stems of trees, and the time during which the bubbles stagnate on the ground surface is long. Therefore, the bubbles will reflect sunlight at these locations so as to suppress increases in air temperature, and will absorb/capture water vapor which has evaporated from tree leaves and the ground surface. This will increase the humidity of the ground surface and inhibit drying, and thus this may lead to a suppression of forest fires.

### Embodiment 6

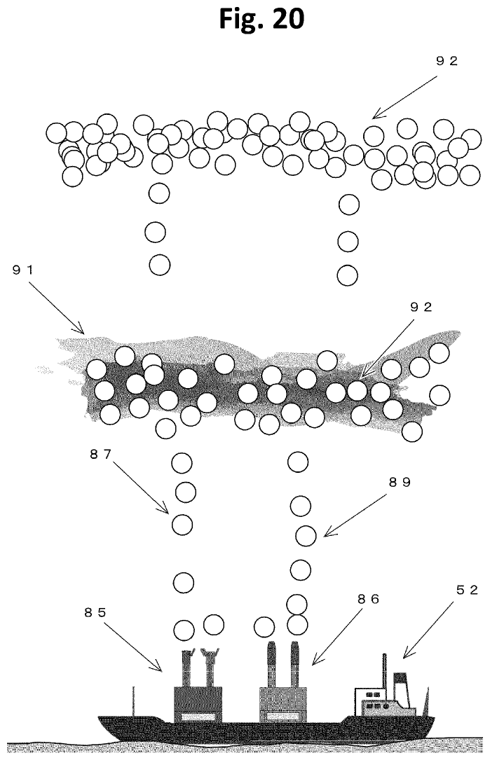

In Embodiment 6, the structure that is equipped with a bubble generation device for geoengineering is a ship when the discharged bubbles have a lower specific gravity than the nearby atmosphere. Embodiment 6 shall be explained using FIGS. 19 to 21.

In FIG. 19, both a foaming device 85 for film membrane bubbles in which the membrane is a resin film, and a foaming device 86 for aqueous membrane bubbles in which the membrane is a liquid are mounted on a tanker 52. When it is necessary to distinguish the type of membrane, the case of a resin membrane shall be indicated as film membrane bubbles 87, and the case of a membrane in which water is the main component shall be indicated as aqueous membrane bubbles 89. In the foaming devices used in the embodiments described above, outside air was taken in from an air intake port opened to the outside, and the outside air was made to contact a foaming net which is uniformly wetted with bubble aqueous solution to generate bubbles.

Herein, in the case of liquid membrane bubbles, a gas such as hydrogen, nitrogen, or helium which is stored in a dedicated cylinder (not illustrated) is mixed in a gas mixer (not illustrated) to produce a floating gas with an appropriate density, and this floating gas is made to contact a foaming net which is uniformly wetted with bubble aqueous solution to generate bubbles. In other words, in the above embodiments, outside air was being filled into the bubbles, whereas in this embodiment, a density-adjusted floating gas is filled instead of the outside air. The term “specific gravity” as used herein indicates a comparison of the combined weight of the bubble membrane and the internal gas therein, i.e. the weight of the bubble, with the weight of the same volume of greenhouse gas or ambient atmospheric air.

In the case of a film packaging bag, a gas is commonly filled therein. In a film packaging bag (a) for snack confectionaries such as potato chips, the packaging is commonly carried out by appropriately blending and filling a nitrogen gas or carbon dioxide, etc. in order to prevent rotting, deterioration, damage, and the like of the confection packaged therein. Further, in a film bag (b) or (c) serving as air cushioning material, a method of filling with air is commonly used. Herein, similar to the aqueous membrane bubbles 89, a gas such as hydrogen, nitrogen, or helium which is stored in a dedicated cylinder is mixed in a gas mixer (not illustrated) to produce a floating gas with an appropriate weight, and this floating gas is filled into the film membrane bubbles 87.

In a method for producing the film membrane bubbles 87 having the same shape as a film bag, a common air cushioning material manufacturing device may be used to fill the floating gas adjusted to an appropriate density as described above. Further, a molten resin which has been extruded by an extruder may be directly processed into a tube-shaped film using floating gas instead of air by a calendar manufacturing method in which air was conventionally used, and the tube-shaped film filled with the floating gas is then heat-sealed or the like in a transverse direction at desired lengths and subsequently cut to produce the film membrane bubbles 87.

If a floating gas which is lighter than air is filled into the bubbles to make the weight of the bubbles lighter than the surrounding air of the same volume, the bubbles will obtain buoyancy from the atmosphere after separating from the discharge port and accelerate on their own to continue to rise. Therefore, each bubble will separate from subsequent bubbles and diffuse as the distance from the subsequent bubbles increases. A film membrane bubble 88 is depicted in an enlarged manner, and an aqueous membrane bubble 90 is depicted in an enlarged manner in a foam state. These bubbles may be in the form of a foam, or in the form of individual air bubbles. Since the bubbles receive buoyancy and rise upward and become lighter as the air density decreases along with an increase in altitude, the bubbles will rise until they become the same weight as the surrounding air. This means that the bubbles can be made to ascend with a focus on a desired height. If a layer 91 in which the density of greenhouse gases is high exists at a certain altitude of the atmosphere, this height can become the focus, and the weight of the bubble including the floating gas can be adjusted so that the bubbles rise to this height and then remain there.

The bubbles discussed up to Embodiment 5 were bubbles that gradually fall onto the ocean surface, whereas the bubbles having an adjusted specific gravity are bubbles that move upward. If the number of bubbles increases to a large amount, the total surface area of the overall bubbles will increase similar to activated carbon, and the chances that these bubbles as a whole will approach, directly contact, and adsorb greenhouse gases will increase. Since the aqueous film bubbles 89 are generally adsorptive, these bubbles may adsorb greenhouse gases. If a substance which easily binds to greenhouse gases is mixed into the bubble membrane so as to absorb carbon dioxide, the possibility of capture by adsorption, absorption, or chemical binding and the like arises.

Further, if the greenhouse gas adsorption capacity could be increased by electrically charging the membrane, then the membrane may be electrically charged. An ionic surfactant is ionized into ions when dissolved in water. For example, with a cationic surfactant, a hydrophobic portion is ionized into positive ions on the surface side of the bubble membrane, and thus a cationic surfactant exhibits a property of strongly adsorbing to a solid surface which is negatively charged. An anionic surfactant is the opposite. If greenhouse gases easily adsorb to bubbles which are electrically charged, then the bubble material could be configured accordingly. Further, in the case of dried bubbles, a static electricity generator can be connected to the bubble discharge port or the foaming net to impart a desired charge, and the discharged bubbles would thus become charged upon contact with the bubble discharge port or the foaming net.

In addition, by appropriately managing the size of the bubbles and the density of the gas to be filled therein so that the weight of the bubbles becomes approximately uniform and then these bubbles are made to ascend, the bubbles will accumulate near where the bubbles stop ascending, and thus a bubble layer or a bubble cloud 92 can be produced at a desired altitude in the atmosphere. Greenhouse gases are believed to move together with tradewinds, jet streams, seasonal winds, and the like. By making the weight of the bubbles approximately equal to the weight of greenhouse gases of the same volume, it is believed that the bubbles can be made to move together with the greenhouse gases. If the bubbles follow the moving greenhouse gases, then the possibility of capture by approaching, contacting, adsorbing, absorbing, chemical bonding, and the like will increase, and the greenhouse gases can then be recovered when the bubbles fall to the Earth.

If a large amount of bubbles are dispersed into the atmospheric layer, the greenhouse gases which are diffused in this atmospheric layer can be recovered, and depending on the amount of bubbles, it may even be possible to return to the atmospheric carbon dioxide concentration that was present before the industrial revolution. The film membrane bubbles 87 can be produced by vacuum deposition processing or sputtering of a ceramic or metal thin film having high sunlight reflectivity, and the film may be subjected in advance to a treatment for thin films with a high sunlight reflectivity.

When bubbles are filled with a floating gas and made to ascend upward from the ground, in higher layers where the atmospheric pressure is low, the probability that the bubble will expand and burst increases, so the aim for these bubbles should be no higher than these higher layers. FIG. 21 illustrates a foam 93 of a type in which smaller bubbles are on the inside of larger bubbles, and these smaller bubbles do not share a membrane with the larger bubbles. A large bubble 94 is released from a low layer such as from the ground, and is constituted using a floating gas having a density such that the bubble will rupture in intermediate layers. Upon arriving at the intermediate layers, the bubble will expand and burst, and the medium bubbles 95 encompassed therein are released. The medium bubbles 95 are filled with a gas having a density such that the bubbles will not burst at the intermediate layers, so these bubbles rise further. Once these medium bubbles 95 reach the higher layers and burst in the higher layers, small bubbles 96 are released, and the small bubbles 96 do not burst at this height and begin to rise. These small bubbles will ascend to the upper reaches of the atmosphere to which the medium bubbles 95 could not ascend.

Further, in FIG. 19, bubbles were dispersed from a tanker on the ocean where the atmospheric pressure is high, but if bubbles are dispersed from a balloon traveling at an altitude where the atmospheric pressure is low, the bubbles can be made to ascend to even higher altitudes. Cases in which the structure equipped with a bubble generation device is a ship have been explained above, but as long as a dedicated foaming device can be installed, the structure is not limited to ship, and may be a vehicle or train which travels over the ground, an airplane, or a tower installed on the ground, or a high-rise building. Geoengineering is mainly classified into two types, namely solar radiation management using the reflection of sunlight, and carbon dioxide removal. Bubbles dispersed into the atmosphere fulfill both of these functions.

### Embodiment 7

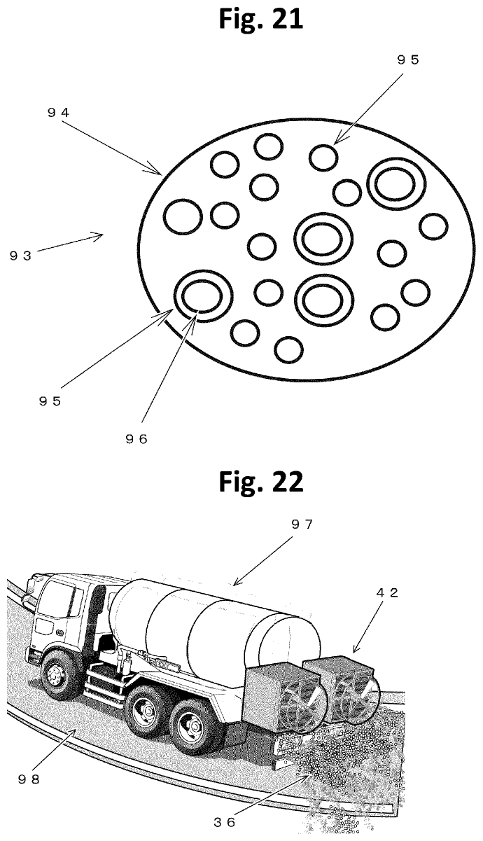

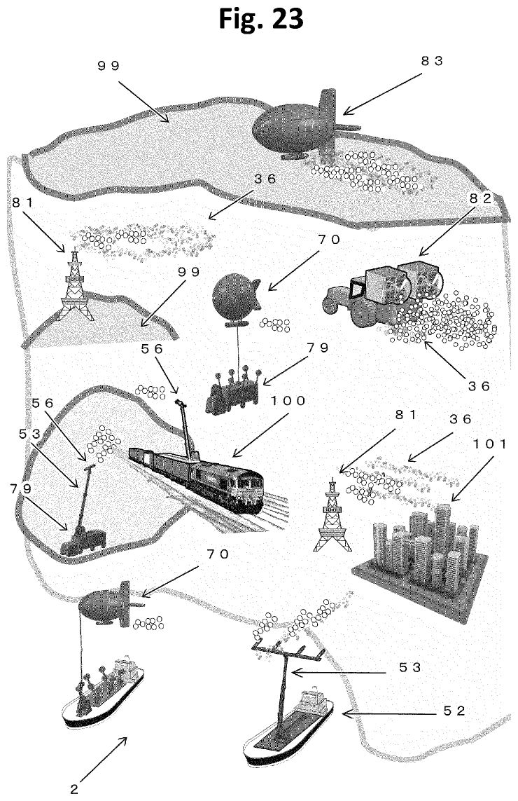

Embodiment 7 uses FIGS. 22 and 23 to propose a way of responding to heatwaves utilizing the methods of the embodiments explained above.

The jet stream in the northern hemisphere is generated by a temperature difference between the cold winds at the North Pole and the warm winds of the tropical regions. However, in recent years, global warming is progressing particularly at the North Pole, and the air temperature is rising due to a loss of sea ice. Thus, the temperature difference from the tropical regions has become smaller and the jet stream has become slower. This has worsened meandering of the jet stream, and during the summer, there are cases in which the jet stream stagnates at the same location for several weeks. At places where the jet stream becomes shaped like a Q, high-reaching high atmospheric pressure becomes trapped leading to a so-called blocking state. This causes fair weather to persist and the temperature to rise. When hot air from the Sahara Desert in Northern Africa flows into such places on the westerly winds, this leads to even further increases in air temperature, and it has been hypothesized that these phenomena were the cause of a heatwave in 2003 which killed 52,000 people in Europe.

Along with the occurrence of the El Niño phenomenon, the air temperature in the troposphere is rising about a half a year late, and it has been theorized that this causes a change in the movement of sea currents and westerly winds which has an effect on heatwaves. Heat waves in Europe occur over a broad range of the European continent involving many countries. Thus, in order to respond to the direct and indirect causes of these heatwaves, we propose a method of combining the methods proposed above to respond to the regions where heatwaves develop and their causes.

The phenomenon of heat waves occurs in lands such as the European continent, the North American continent, and the Australian continent. However, the area used in this embodiment will be a region with an area on the same scale as that of the Australian continent used in Embodiment 2. In the case of the ocean, such a large area was able to be covered by increasing the number of ships. But in the case of a continent, ships can only get close to the shore thereof, and there are places where vehicles can travel but also places where vehicles cannot travel, and there are various topographies such as undulating lands, rivers, cities, farm fields, forests, and the like. Structures with embodiments capable of handling each of these topographies shall be utilized.

For a road 97, a bubble generation device is installed on a vehicle 97 for traveling on roads as illustrated in FIG. 22, and bubbles are dispersed thereby to improve the albedo of the road. FIG. 22 illustrates a dedicated vehicle, but the bubble generation device can be made compact or fashioned into a unit which can be attached later so that the bubble generation device can be mounted on a private car, a regular bus, a long-distance truck, or the like and combined with a rearward monitor so that bubbles can be dispersed without affecting vehicles to the rear. A vehicle 82, which is capable of traveling over non-paved areas used in deserts, is used to disperse bubbles over farm fields, riverbeds, and wastelands. A ground installation-type tower 81 is installed on a hill 99 positioned in the wind in a region with strong winds, and bubbles are dispersed into the atmosphere from a foaming device installed at the top of the tower during a desired period in which there is a risk of a heatwave. This installation-type tower 81 is also installed in a region positioned in the wind near a city, and a bubble generation device is installed on a high-rise building of a city 101 to disperse bubbles into the sky over the city.

A structure in which a foaming device 56 is installed at the top of a tower 53 mounted on a trailer which is used in the desert is disposed in a desired region and made to generate bubbles. A train 100, on which is mounted a folding tower-type bubble generation device, is placed in a desired region to disperse bubbles. In Embodiment 4, a trailer-type structure 79 on which is mounted a bubble generation device using a tethered balloon 70 was proposed, and herein as well, this structure is placed in a desired region to disperse bubbles. In Embodiment 2, a tanker-type structure 52 on which a tower-style bubble generation device is mounted was proposed, and in this embodiment, the ship is placed in lakes and rivers at places which contact the wind in regions covered by high atmospheric pressure, or in nearby oceans to disperse bubbles. Lakes and oceans are advantageous for securing water for the bubble raw material.

In Embodiment 6, a structure with a configuration in which bubbles filled with a light gas are dispersed from a tanker was proposed. Herein, this configuration is mounted onto a structure located in an inland area such as a vehicle, a train, or a ground facility to disperse bubbles into the sky. If there is a region in the sky above a city where the air current is stable, it is possible to create a cloud of bubbles, and thereby an effect similar to opening a parasol in the sky over a city can be achieved. A free airship can reach places where there are no roads or rivers to disperse bubbles in these places. In a desired region, bubbles are dispersed into the atmosphere using a free airship 83 equipped with a bubble generation device.

The above-described measures are for areas which are directly covered by high atmospheric pressure. In the following, measures for responding to phenomena in regions which are said to be indirectly affected by heatwaves even though they are far from the above-mentioned areas shall be proposed. One factor which worsens heatwaves in Europe is theorized to be that air which is heated in the Sahara Desert flows on the westerly winds to the European continent. Herein, the method proposed in Embodiment 4 is implemented in affected deserts to suppress an increase in the air temperature of such deserts. Further, the El Niño phenomenon is also theorized to be a factor, and thus a desired method from those of Embodiments 1 to 6 is selected to disperse bubbles in advance in regions where a rise in seawater temperature due to the El Niño phenomenon is expected, so as to suppress an increase in the seawater temperature. In addition, besides ocean regions where the El Niño phenomenon is monitored, similar measures are taken in regions where a rise in seawater temperature affects heatwaves.

In order to suppress the rising of the air temperature in polar regions such as the North Pole and suppress the melting of ice, a desired method from those of Embodiments 1 to 6 is used to disperse bubbles over the ocean, over the ice, and in the sky at the North Pole, and thereby improve the albedo. The bubbles dispersed over land, ocean, and ice at the polar regions becomes embedded in snow when snow is falling, and thus it becomes snow and ice which include bubbles, or in other words air, and this causes air, snow, and ice to mix together. When this occurs, the heat transfer coefficient decreases, and thus the ice is less prone to melt. In the polar regions, if a large amount of bubbles are dispersed so as to increase the area of ice with a small heat transfer coefficient, this can yield an advantage because the speed at which the ice melts with respect to the air temperature and wind, which are factors leading to ice melt, decreases. Heatwave phenomena in the southern hemisphere is believed to be related to global warming at the South Pole instead of the North Pole. Therefore, it is believed that combining the above with bubble dispersement at the South Pole can serve as a measure against similar phenomena in the southern hemisphere.

Embodiment 2 introduced a measure to be used in an ocean with an area equivalent to Australia. In contrasts, heatwaves are problems in lands having a similar area. If a considerable number of current techniques and equipment are used, foam can be generated in a short amount of time in high quantities which can cover a broad area, and the present invention also enables large amounts of foam to be thinly spread and dispersed over a broad area. If the proposed methods are combined on land similar to their use over the ocean, it will be possible to improve the worsening of the thermal environment due to sunlight in a vast land region such as the European continent during a desired period in a short amount of time.

### REFERENCE SIGNS LIST

1: independent air bubble
(b): air cushioning material
2: ocean surface
3: incident light
4: reflected light
5: seawater
6: refracted light
9: bubble
10: membrane
11, 12, 17, 18: reflection surface
13, 15, 19, 21: transmitted light
14, 16, 18: reflected light
22: foam
23: membrane
24: reflection surface
31: bubble layer
32: foaming net
33: ship
36: bubble, foam
37: wake wave
42: foaming device
46: bubble discharge port
47: rotary vane
48: wave maker
51: tethered balloon device
52: tanker
53: tower
56: foaming device
58: jet fan
59: spray nozzle
60: foaming net
65: discharge port
66: turbulence generator
69: cutting blade
70: tethered balloon
75: tethering rope
81: ground installation-type tower
83: free airship
84: rectangular parallelepiped
(A): side surface view
(B): plan view
91: layer in which the density of greenhouse gases is high
92: bubble layer or bubble cloud
93: foam of a type in which bubbles do not share a membrane
100: train

1. A structure comprising a bubble generation device for geoengineering, wherein said structure is characterized by being:
(A) a structure having an effective relative velocity difference with respect to an atmosphere so that a desired area of the structure which contacts the atmosphere can generate turbulence which breaks down bubbles; or
(B) a structure that can maintain an effective relative velocity difference with respect to seawater so that wake waves which break down foam that has dropped onto a water surface from a bubble discharge port can be generated,
wherein at least one foaming device, to which a rotary vane that serves as a turbulence generation device and a foam cutter is attached near the bubble discharge port, is installed on one of the above structures.

2. A structure comprising a bubble generation device for geoengineering, wherein said structure is characterized by being:
(A) a structure having an effective relative velocity difference with respect to an atmosphere so that a desired area of the structure which contacts the atmosphere can generate turbulence which breaks down bubbles; or
(B) a structure that can maintain an effective relative velocity difference with respect to seawater so that wake waves which break down foam that has dropped onto a water surface from a bubble discharge port can be generated,
wherein the structure includes a turbulence generation device, a foam cutter, or a wave maker for breaking down released bubbles, and
wherein at least one foaming device, to which a rotary vane that serves as a turbulence generation device and a foam cutter is attached near the bubble discharge port, is installed on one of the above structures.

3. The structure according to claim 1, characterized in that:
the structure is a ship equipped with the bubble generation device, wherein an expandable frame capable of projecting over an ocean surface from a side of the ship is attached onto a deck of the ship, and foaming devices are attached to the expandable frame so that the bubble discharge ports of the foaming devices face downward or to the rear when the expandable frame has been extended to the outside of the ship, and a wave maker is further attached to a hull of the ship.

4. The structure according to claim 1, characterized in that:
the structure is a ship equipped with the bubble generation device, wherein a tower is installed onto a deck of the ship, the tower extending up into a strong wind region having the effective relative velocity difference with respect to the atmosphere so as to generate the turbulence which breaks down the bubbles at the desired area which contacts the atmosphere, wherein a blade projecting to the left and right is attached to an upper part of the tower, and wherein foaming devices are attached to the blade separated by a distance from each other such that bubbles which are released do not interfere with each other, and the discharge ports are oriented opposite a traveling direction of the ship.

5. The structure according to claim 1, characterized in that:
the structure is a ship equipped with the bubble generation device, wherein a tethered balloon is installed onto a deck of the ship, wherein the tethered balloon is raised into a strong wind region where the effective relative velocity difference with respect to the atmosphere is generated so as to generate the turbulence which breaks down the bubbles at the desired area which contacts the atmosphere, wherein the foaming device is suspended from the tethered balloon, and wherein a hose for pressure feeding a foaming aqueous solution from the bubble generation device is attached to the foaming device, the hose also serving as a tethering rope for connecting the tethered balloon to the ship.

6. The structure according to claim 1, characterized in that:
the structure is a free airship which can travel through a strong wind area where the effective relative velocity difference with respect to the atmosphere is generated so as to generate the turbulence which breaks down the bubbles at the desired area which contacts the atmosphere, wherein the free airship is equipped with the bubble generation device, and the foaming device, to which the rotary vane that serves as the turbulence generation device and the foam cutter is attached near the bubble discharge port, is installed on the bubble generation device.

7. The structure according to claim 1, characterized in that:
the bubble generation device generates the bubbles to be discharged which have a lower specific gravity than the atmosphere so that the bubbles obtain buoyancy from the atmosphere after separating from the bubble discharge port and accelerate on their own to continue to rise and separate from subsequent bubbles and diffuse as the distance from the subsequent bubbles increases.
